(19) United States
(12) Patent Application Publication
(10) Pub. No.: US 2026/0347192 A1
(43) Pub. Date: Nov. 5, 2026

(54) MICROWAVE-ASSISTED QUASI-GRAPHITIC STRUCTURE SYNTHESIS

(71) Applicant: Khalifa University of Science and Technology, Abu Dhabi (AE)

(72) Inventors: Yarjan Abdul Samad, Abu Dhabi (AE); Chanaka Sandaruwan, Abu Dhabi (AE); Rami Elkaffas, Abu Dhabi (AE); Fahad Al Absi, Abu Dhabi (AE); Dalaver Hussain Anjum, Abu Dhabi (AE)

(73) Assignee: Khalifa University of Science and Technology, Abu Dhabi (AE)

(21) Appl. No.: 19/668,253

(22) Filed: May 5, 2026

Related U.S. Application Data
(60) Provisional application No. 63/800,379, filed on May 5, 2025.

(51) Int. Cl. C01B 32/205

(52) U.S. Cl. CPC C01B 32/205; C01P 2002/72; C01P 2002/82; C01P 2002/85; C01P 2004/03; C01P 2004/04; C01P 2006/12; C01P 2006/40; C01P 2006/80

(57) ABSTRACT

Methods of producing 2D turbostratic or quasi-crystalline carbon materials using microwave irradiation are described. The methods include mixing a carbon source and an energy transferring agent and subjecting the mixture to microwave radiation. The methods can include performing the irradiation in a vacuum or in inert atmospheres. Also disclosed herein are 2D turbostratic or quasi-crystalline carbon materials for use in energy storage devices, water and air purification systems, and sensor devices.

### CROSS-REFERENCES TO RELATED APPLICATIONS

This application claims the benefit of U.S. Provisional Application No. 63/800,379 filed May 5, 2025, the entire contents of which are hereby incorporated for all purposes in their entirety.

### BACKGROUND OF THE INVENTION

The synthesis of two-dimensional (2D) carbon-based materials, including graphitic and quasi-graphitic structures, has been an active area of research due to their superior mechanical strength, electrical conductivity, and thermal properties. In recent years, increased attention has been directed toward the development of turbostratic or quasi-crystalline carbon materials, which are distinguished by unique electrical, optical, and mechanical characteristics. Such materials are considered promising for a variety of applications, including but not limited to, energy storage devices, catalyst systems, composite materials, water and air purification, and sensor technologies. For instance, their high surface area and abundance of active sites make them attractive for use in batteries, supercapacitors, and as electrode materials and components. In addition, their structural features are advantageous for catalysis and adsorption processes, as well as enhancing the performance of composite materials and environmental remediation systems.

Despite these potential advantages, conventional synthesis methods for turbostratic or quasi-crystalline carbon structures, such as chemical vapor deposition (CVD), flash Joule heating, laser-assisted synthesis, detonation synthesis, dry ice methods, and negative carbon ion implantation, face significant challenges when scaled to industrial production. These challenges include the need for specialized equipment, difficulties in achieving uniform and high-purity products, scalability limitations, process complexity, safety concerns, and the potential for unwanted impurities. As a result, there remains a need for the development of scalable, efficient, and cost-effective processes for the bulk synthesis of turbostratic and quasi-crystalline carbon materials.

### BRIEF SUMMARY OF THE INVENTION

Covered embodiments of the present disclosure are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings and each claim.

In one aspect a method of producing a 2D carbon structure is provided. The method may include providing a carbon source, adding, to the carbon source, an intermediate energy transferring agent, to produce a mixture, and subjecting the mixture to microwave radiation for a period of time to produce a 2D carbon structure. The 2D carbon structure may be a turbostratic or quasi-crystalline carbon material. The carbon source may be cellulose, lignin, coke, or a combination thereof. The intermediate energy transferring agent comprises a graphitic carbon material, graphene, a nanocrystalline carbon material, or a graphene derivative. The microwave radiation is applied in an inert environment. The microwave radiation may be applied for a period of time from 0.5 minutes to 60 minutes. In some embodiments, the mixture is subjected to microwave radiation at a power of at least 500 Watts. In some embodiments, the microwave radiation is applied at a frequency in a range from about 300 MHz to about 30 GHz. The method may further include isolating the 2D carbon structure from the mixture after microwave irradiation. In some embodiments, the 2D carbon structure produced has a higher purity than the carbon source.

In another aspect, provided herein is a method of producing a turbostratic or quasi-crystalline material. The method comprising providing a carbon source, adding, to the carbon source, an energy transferring agent to produce a mixture, and subjecting the mixture to microwave radiation under inert conditions for a period of time, thereby producing a turbostratic or quasi-crystalline carbon material. In some embodiments, energy transferring agent is selected from the group consisting of high purity graphite, ceramics, sacrificial microwave susceptors, graphene, graphitic carbon, a nanocrystalline carbon, or a graphene derivative. In some embodiments, the energy transferring agent provides energy to the carbon source without contaminating the turbostratic or quasi-crystalline carbon material. In some embodiments, the turbostratic or quasi-crystalline carbon material has a surface area of greater than 200 m²/g. In some embodiments, the inert conditions comprise an atmosphere of argon or nitrogen. In some embodiments, the carbon source is selected from waste biomass, coke waste, or industrial byproducts. In some embodiments, the turbostratic or quasi-crystalline carbon material is characterized by unaligned fringes as observed in transmission electron microscopy. In some embodiments, the process yields a product with improved electrical conductivity compared to the carbon source. The method may further comprise using the turbostratic or quasi-crystalline carbon material as an electrode material in an energy storage device. The turbostratic or quasi-crystalline carbon material has a purity of at least 95%. The turbostratic or quasi-crystalline carbon material may be suitable for use in water purification or sensor applications.

In a further aspect, provided herein are two-dimensional (2D) turbostratic or quasi-crystalline carbon material produced by the methods described herein. The carbon material may exhibit a Raman spectrum with D, G, and 2D peaks.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 illustrates a schematic flow diagram of a representative process for synthesizing two-dimensional (2D) turbostratic or quasi-crystalline carbon materials via microwave-assisted methods, according to aspects of the present disclosure.

FIG. 2 illustrates a schematic flow diagram of an alternative process for synthesizing two-dimensional (2D) turbostratic or quasi-crystalline carbon materials utilizing microwave-assisted methods under inert conditions, according to aspects of the present disclosure.

FIG. 3A illustrates a representative structural model of a turbostratic or quasi-crystalline carbon material produced using the microwave synthesis process of FIG. 1, according to aspects of the present disclosure.

FIG. 3B illustrates a representative structural model of a turbostratic or quasi-crystalline carbon material produced using the microwave synthesis process of FIG. 2, according to aspects of the present disclosure.

FIG. 4 shows scanning electron microscopy (SEM) images depicting the morphological features of turbostratic or quasi-crystalline carbon materials synthesized according to the methods described herein.

FIG. 5 shows transmission electron microscopy (TEM) images demonstrating the microstructural characteristics of turbostratic or quasi-crystalline carbon materials synthesized from cellulose, coke, and lignin using the methods described herein.

FIG. 6A shows powder X-ray diffraction (PXRD) analysis of turbostratic or quasi-crystalline carbon materials synthesized from (a) cellulose and (b) coke fine ash, according to methods described herein.

FIG. 6B shows powder X-ray diffraction (PXRD) analysis of turbostratic or quasi-crystalline carbon materials synthesized from (c) coke waste and (d) lignin, according to methods described herein.

FIG. 6C shows powder X-ray diffraction (PXRD) analysis of turbostratic or quasi-crystalline carbon materials synthesized from lignin using the process of FIG. 2, according to aspects of the present disclosure.

FIG. 7A shows Raman spectra of cellulose subjected to the process of FIG. 2, comparing samples exposed to microwave radiation for 1 minute (top), 3 minutes (middle), and a graphene-only reference (bottom), according to aspects of the present disclosure.

FIG. 7B shows Raman spectra of lignin subjected to the process of FIG. 2, comparing samples irradiated under various durations (from 20 minutes to 1 minute) in oxygen or inert gas environments, as well as a carbon black reference, according to aspects of the present disclosure.

FIG. 8A shows X-ray photoelectron spectroscopy (XPS) O1s narrow scan spectra of cellulose prior to microwave irradiation, according to aspects of the present disclosure.

FIG. 8B shows X-ray photoelectron spectroscopy (XPS) O1s narrow scan spectra of turbostratic or quasi-crystalline carbon materials synthesized from cellulose using microwave irradiation, according to aspects of the present disclosure.

FIG. 8C shows X-ray photoelectron spectroscopy (XPS) O1s narrow scan spectra of lignin prior to microwave irradiation, according to aspects of the present disclosure.

FIG. 8D shows X-ray photoelectron spectroscopy (XPS) O1s narrow scan spectra of turbostratic or quasi-crystalline carbon materials synthesized from lignin using microwave irradiation, according to aspects of the present disclosure.

### DETAILED DESCRIPTION OF THE INVENTION

The following description recites various aspects and embodiments of the present compositions and methods. No particular embodiment is intended to define the scope of the compositions and methods. Rather, the embodiments merely provide non-limiting examples of various compositions and methods that are at least included within the scope of the disclosed compositions and methods. The description is to be read from the perspective of one of ordinary skill in the art; therefore, information well known to the skilled artisan is not necessarily included.

### Introduction

Two-dimensional (2D) carbon structures, including turbostratic and quasi-crystalline graphitic materials, have attracted significant scientific and commercial interest due to their remarkable combination of mechanical strength, electrical conductivity, and thermal stability. These advanced carbon materials are increasingly sought after for a broad spectrum of applications, including high-performance energy storage devices, efficient electrocatalysts, composite reinforcement, environmental remediation, and chemical sensing. Their unique layered and disordered architectures provide extensive surface area, abundant active sites, and electronic decoupling, enabling performance characteristics that surpass those of conventional graphitic or amorphous carbons. While a variety of methods exist for producing such materials, such as Chemical Vapor Deposition (CVD), Flash Joule Heating (FJH), laser-assisted synthesis, and detonation techniques, these approaches often require high temperatures, inert or reducing atmospheres, complex multi-step processing, or costly and specialized equipment. Furthermore, many existing methods suffer from limitations in scalability, product uniformity, safety, and achievable material purity, which collectively restrict their practical adoption for large-scale industrial use.

Microwave-assisted synthesis, particularly in the form of rapid “flash” microwave processing, has emerged as a transformative approach for the controlled production of quasi-graphitic and turbostratic carbon structures. In this technique, a suitable carbonaceous precursor (e.g., such as cellulose, lignin, coke, or carbon waste) is exposed to intense microwave radiation, often in the presence of an energy-transferring agent (e.g., nanocrystalline carbon or graphitic derivatives). The unique interaction of microwave energy with the material results in rapid, volumetric heating, which can drive localized temperatures to several hundred or even thousands of degrees Celsius within seconds or minutes. This “flash” heating not only accelerates the carbonization and graphitization processes but also promotes the formation of turbostratic and quasi-crystalline domains by enabling dynamic rearrangement of carbon atoms and layer stacking faults under non-equilibrium conditions. The use of microwaves allows for precise control over heating rates and reaction environments (including inert atmospheres if desired), minimizing the introduction of impurities and reducing energy consumption. Unlike conventional thermal methods, the microwave process can be highly scalable, does not require complex reactor geometries, and is amenable to continuous or batch operation with various feedstocks (e.g., biomass and industrial byproducts). As a result, microwave-assisted “flash” synthesis holds significant promise for delivering high-quality, structurally tunable carbon materials in a manner that is both cost-effective and environmentally sustainable.

Provided herein are methods and compositions for the rapid and scalable synthesis of turbostratic and quasi-crystalline carbon structures using a novel microwave-assisted flash process. The disclosed technology enables the efficient transformation of a variety of carbon sources into advanced graphitic materials under controlled conditions, offering significant advantages in scalability, cost, and material quality over conventional synthesis routes.

### Definitions

Unless defined otherwise, all technical and scientific terms used herein have the same meaning as commonly understood by one of ordinary skill in the art to which this invention belongs. Although, any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

Articles “a” and “an” are used herein to refer to one or to more than one (i.e., at least one) of the grammatical object of the article. By way of example, “an element” means at least one element and can include more than one element.

As used herein, the terms "optional" or "optionally" as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein. The transitional phrase “consisting essentially of” (and grammatical variants) is to be interpreted as encompassing the recited materials or steps “and those that do not materially affect the basic and novel characteristic(s)” of the claimed invention. See, e.g., In re Herz, 537 F.2d 549, 551-52 (CCPA 1976) (emphasis in the original); see also MPEP § 2111.03. Thus, the term “consisting essentially of” as used herein should not be interpreted as equivalent to “comprising.”

As used herein, “turbostratic” as used herein refers to a disordered form of a layered material, most commonly carbon or graphene, where basal planes are parallel but rotated or slipped out of alignment relative to each other. Unlike ordered AB-stacked graphite, these layers are decoupled electronically and optically. It is characterized by high interlayer spacing, low adhesion between layers, and is often produced via fast synthesis methods.

As used herein, “quasi-crystalline” refers to an ordered matter that possesses a structure arrangement between that of a crystal and an amorphous solid.

Methods of preparing turbostratic and quasi-crystalline carbon structures

The present disclosure relates to methods for synthesizing two-dimensional (2D) turbostratic or quasi-crystalline carbon materials using a microwave-assisted process. The methods described herein enable the production of high-surface-area carbon structures with desirable electrical, mechanical, and chemical properties from a variety of carbon sources. The process is both facile and scalable, overcoming challenges of contamination and non-uniformity often observed in conventional synthesis techniques.

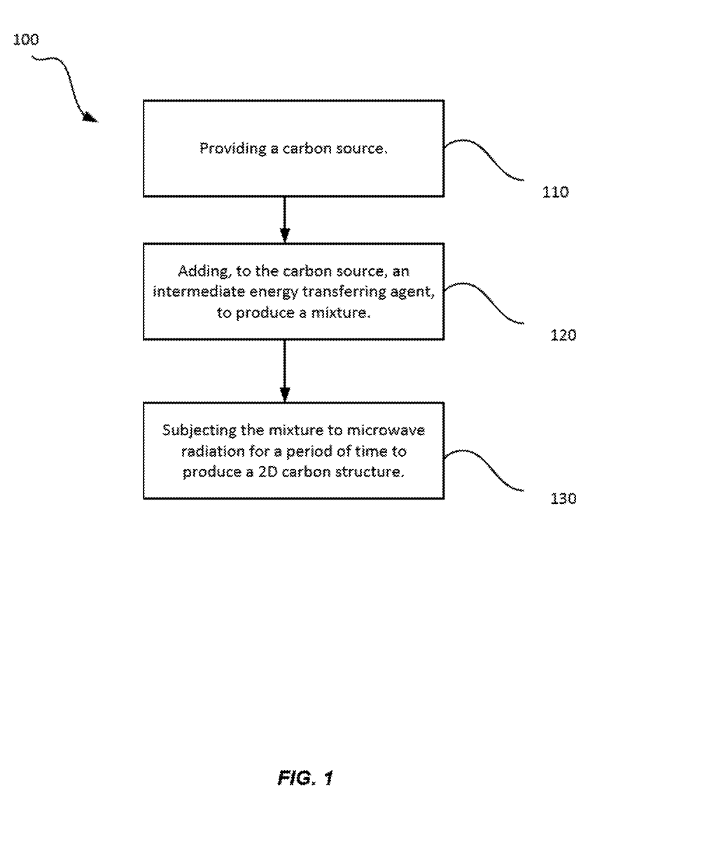

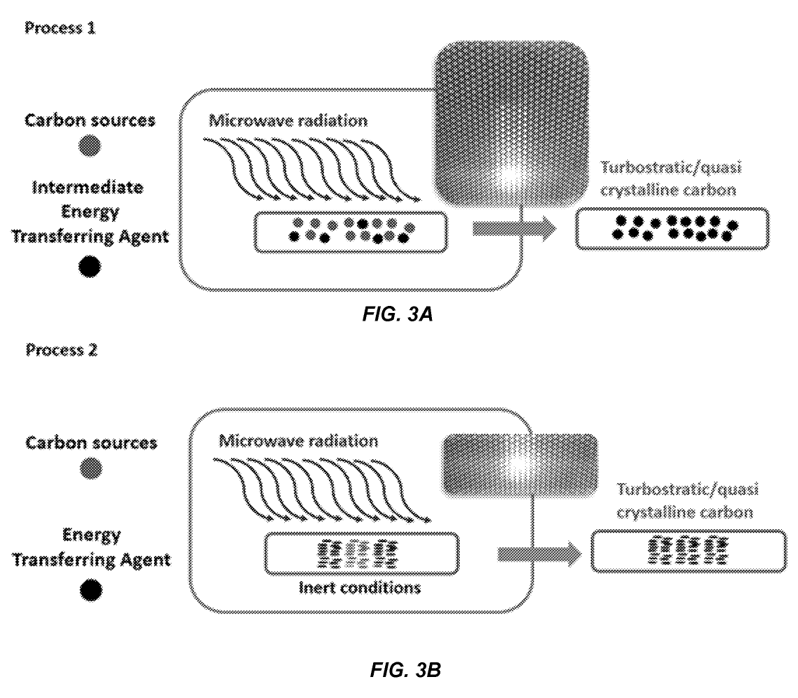

In one aspect, a method for producing a 2D carbon structure is provided. Referring to FIG. 1, the method 100 includes three principal steps: (1) providing a carbon source (110), (2) adding an intermediate energy transferring agent to the carbon source to form a mixture (120), and (3) subjecting the mixture to microwave radiation to produce a 2D turbostratic or quasi-crystalline carbon material (130). As described herein, the intermediate energy transferring agent may be referred to an energy transferring agent interchangeably. A schematic of the formation of the turbostratic or quasi-crystalline material may be found in FIG. 3A.

In step 110, a carbon source is selected. The carbon source may be, for example, cellulose, coke, lignin, biomass, or any other organic or carbonaceous material. The selected carbon source may be in the form of a powder, pellet, or other particulate form to facilitate mixing and uniform energy absorption. In some embodiments, the carbon source is derived from waste biomass materials, such as agricultural residues or industrial by-products, providing an environmentally sustainable route for material synthesis. In certain embodiments, the carbon source may be pre-treated to remove moisture or volatiles, or to control particle size distribution, thereby optimizing the subsequent synthesis process.

In step 120, an intermediate energy transferring agent is added to the carbon source to produce a homogeneous mixture. The intermediate energy transferring agent may comprise graphitic carbon materials, such as nanocrystalline graphite, nanocrystalline carbon material, high purity graphite, graphene, graphene oxide, reduced graphene oxide, carbon black, graphene derivatives, or other forms of high microwave-absorbing carbon. In some embodiments, the agent may be selected for its ability to efficiently absorb microwave energy and transfer it to the surrounding carbon source, thereby promoting uniform heating. In some embodiments, the weight ratio of the intermediate energy transferring agent to the carbon source may be adjusted depending on the efficiency of energy transfer desired. In some embodiments, the intermediate energy transferring agent is present in an amount ranging from 1 wt.% to 50 wt.% of the total mixture (e.g., from 1 wt.% to 50 wt.%, from 5 wt.% to 45 wt.%, from 10 wt.% to 50 wt.%, from 15 wt.% to 50 wt.%, from 20 wt.% to 40 wt.% or from 1 wt.% to 25 wt.%) In some embodiments, the intermediate energy transferring agent is present in an amount of 1 wt.%, 2 wt.%, 3 wt.%, 4 wt.%, 5 wt.%, 6 wt.%, 7 wt.%, 8 wt.%, 9 wt.%, 10 wt.%, 11 wt.%, 12 wt.%, 13 wt.%, 14 wt.%, 15 wt.%, 16 wt.%, 17 wt.%, 18 wt.%, 19 wt.%, 20 wt.%, 21 wt.%, 22 wt.%, 23 wt.%, 24 wt.%, 25 wt.%, 26 wt.%, 27 wt.%, 28 wt.%, 29 wt.%, 30 wt.%, 31 wt.%, 32 wt.%, 33 wt.%, 34 wt.%, 35 wt.%, 36 wt.%, 37 wt.%, 38 wt.%, 39 wt.%, 40 wt.%, 41 wt.%, 42 wt.%, 43 wt.%, 44 wt.%, 45 wt.%, 46 wt.%, 47 wt.%, 48 wt.%, 49 wt.%, or 50 wt.%. In some embodiments, the intermediate energy transferring agent may be present in an amount greater than 50 wt.%.

In some embodiments, the mixture may be prepared by simple blending, ball milling, or solution mixing.

In step 130, the prepared mixture is subjected to microwave radiation for a defined period. The microwave processing may be conducted in a conventional or industrial microwave oven, or in a custom reactor designed for controlled synthesis. In some embodiments, the microwave oven may be an industrial sized microwave oven.

The frequency of the microwave radiation used in the synthesis process may be selected based on the desired energy absorption characteristics and the nature of the carbon source and intermediate energy transferring agent. In some embodiments, the microwave frequency ranges from about 300 MHz to about 30 GHz (e.g., from about 300 MHz to about 30 GHz, from about 900 MHz to about 18 GHz, from about 1 GHz to about 10 GHz, from about 2.0 GHz to about 2.5 GHz, from about 2.4 GHz to about 2.5 GHz, or from about 5.8 GHz to about 6 GHz). In some embodiments, the microwave frequency is about 300 MHz, 325 MHz, 350 MHz, 375 MHz, 400 MHz, 425 MHz, 450 MHz, 475 MHz, 500 MHz, 525 MHz, 550 MHz, 575 MHz, 600 MHz, 625 MHz, 650 MHz, 675 MHz, 700 MHz, 725 MHz, 750 MHz, 775 MHz, 800 MHz, 825 MHz, 850 MHz, 875 MHz, 900 MHz, 925 MHz, 950 MHz, 975 MHz, 1.0 GHz, 1.025 GHz, 1.05 GHz, 1.075 GHz, 1.1 GHz, 1.125 GHz, 1.15 GHz, 1.175 GHz, 1.2 GHz, 1.225 GHz, 1.25 GHz, 1.275 GHz, 1.3 GHz, 1.325 GHz, 1.35 GHz, 1.375 GHz, 1.4 GHz, 1.425 GHz, 1.45 GHz, 1.475 GHz, 1.5 GHz, 1.525 GHz, 1.55 GHz, 1.575 GHz, 1.6 GHz, 1.625 GHz, 1.65 GHz, 1.675 GHz, 1.7 GHz, 1.725 GHz, 1.75 GHz, 1.775 GHz, 1.8 GHz, 1.825 GHz, 1.85 GHz, 1.875 GHz, 1.9 GHz, 1.925 GHz, 1.95 GHz, 1.975 GHz, 2.0 GHz, 2.025 GHz, 2.05 GHz, 2.075 GHz, 2.1 GHz, 2.125 GHz, 2.15 GHz, 2.175 GHz, 2.2 GHz, 2.225 GHz, 2.25 GHz, 2.275 GHz, 2.3 GHz, 2.325 GHz, 2.35 GHz, 2.375 GHz, 2.4 GHz, 2.425 GHz, 2.45 GHz, 2.475 GHz, 2.5 GHz, 2.525 GHz, 2.55 GHz, 2.575 GHz, 2.6 GHz, 2.625 GHz, 2.65 GHz, 2.675 GHz, 2.7 GHz, 2.725 GHz, 2.75 GHz, 2.775 GHz, 2.8 GHz, 2.825 GHz, 2.85 GHz, 2.875 GHz, 2.9 GHz, 2.925 GHz, 2.95 GHz, 2.975 GHz, or 3.0 GHz. In some embodiments, the microwave radiation is applied at a frequency greater than about 30 GHz or less than about 300 MHz, depending on the particular apparatus and desired process conditions.

For example, in certain embodiments, the process is carried out at a frequency commonly used in industrial or laboratory microwave reactors, such as about 2.45 GHz or about 915 MHz. In other embodiments, the frequency may be tuned to optimize the energy transfer to the specific combination of carbon source and energy transferring agent. The choice of frequency may be further adjusted based on the dielectric properties of the mixture and the intended scale of production.

The power of the microwave radiation used in the synthesis process may be selected based on the desired energy absorption characteristics and the nature of the carbon source and intermediate energy transferring agent. In some embodiments, the microwave power is at least 500 Watts. For example, the microwave power may be 500 W, 510 W, 520 W, 530 W, 540 W, 550 W, 560 W, 570 W, 580 W, 590 W, 600 W, 610 W, 620 W, 630 W, 640 W, 650 W, 660 W, 670 W, 680 W, 690 W, 700 W, 710 W, 720 W, 730 W, 740 W, 750 W, 760 W, 770 W, 780 W, 790 W, 800 W, 810 W, 820 W, 830 W, 840 W, 850 W, 860 W, 870 W, 880 W, 890 W, 900 W, 910 W, 920 W, 930 W, 940 W, 950 W, 960 W, 970 W, 980 W, 990 W, 1000 W, or any value between 500 W and 1000 W.

The duration of irradiation may range from a few seconds to several minutes, depending on the scale of synthesis, the type of carbon source, and the desired degree of conversion. For example, the duration of irradiation may be from 1 second to 1 hour (e.g., 1 second to 1 hour, from 5 seconds to 30 minutes, from 10 seconds to 10 minutes, from 30 seconds to 5 minutes, from 1 minute to 30 minutes, from 2 minutes to 20 minutes, from 3 minutes to 15 minutes, or from 5 minutes to 10 minutes.) In some embodiments, the duration of microwave irradiation may be specifically selected from 1 second, 5 seconds, 10 seconds, 15 seconds, 20 seconds, 25 seconds, 30 seconds, 35 seconds, 40 seconds, 45 seconds, 50 seconds, 55 seconds, 1 minute, 2 minutes, 3 minutes, 4 minutes, 5 minutes, 6 minutes, 7 minutes, 8 minutes, 9 minutes, 10 minutes, 12 minutes, 14 minutes, 15 minutes, 18 minutes, 20 minutes, 25 minutes, 30 minutes, 35 minutes, 40 minutes, 45 minutes, 50 minutes, 55 minutes, or 60 minutes. In some embodiments, the duration of microwave irradiation may be less than 5 minutes, less than 10 minutes, less than 20 minutes, less than 30 minutes, or less than 1 hour. In other embodiments, the duration may be greater than 1 second, greater than 10 seconds, greater than 1 minute, or greater than 10 minutes. In some embodiments, the duration of microwave irradiation may be optimized depending on the nature of the carbon source, the type and amount of energy transferring agent, the desired purity of the product, and the particular microwave apparatus employed.

In certain embodiments, the process is performed under an inert atmosphere, such as nitrogen, argon, or helium, to prevent oxidation and facilitate the formation of high-purity turbostratic or quasi-crystalline carbon structures. The reaction vessel may be sealed or purged with inert gas prior to irradiation. In other embodiments, the process may be performed under vacuum conditions. The temperature of the mixture during irradiation may be monitored and controlled to avoid thermal runaway or unwanted side reactions.

The application of microwave energy to the mixture results in rapid and volumetric heating, which initiates the transformation of the carbon source into a 2D turbostratic or quasi-crystalline structure. The use of an intermediate energy transferring agent ensures that energy is efficiently absorbed and distributed, leading to uniform conversion and minimizing the formation of amorphous or contaminated by-products. The resulting product may exhibit a layered morphology with unaligned or rotationally disordered stacking. Characteristics of turbostratic carbon may be observed by transmission electron microscopy (TEM) and powder X-ray diffraction (PXRD).

In one embodiment, the process is scalable for gram-scale to kilogram-scale synthesis, and can be adapted for continuous processing by feeding the carbon mixture into a microwave reactor equipped with a conveyance system. The product may be collected, washed, and dried as needed for downstream applications. In some embodiments, the resulting turbostratic or quasi-crystalline carbon material may be employed in energy storage devices, used as a catalyst system, employed as a composite material, used in water and air purification systems or employed in sensor materials. For example, in energy storage devices, turbostratic or quasi-crystalline carbon materials produced herein may be used due to their higher surface area for providing higher energy storage capacity and faster charge/discharge ratios. The improved electrical conductivity of said materials can be a suitable candidate for the electrode materials. The turbostratic or quasi-crystalline carbon materials described herein may be used as catalyst systems due to their disordered nature or quasi-crystalline structure, that provides active sites to facilitate different chemical reactions. In composite materials the turbostratic or quasi-crystalline carbon materials provided herein may enhance the mechanical, electrical, and optical properties of composites. Additionally, in water and air purification systems, the turbostratic or quasi-crystalline carbon materials described herein can be used due to their distorted structure that leads to tortuous paths and a larger number of active sites. And finally, in sensor materials, the higher surface area of the turbostratic or quasi-crystalline carbon material makes them suitable for gas and other molecule sensing elements. Thus, the turbostratic or quasi-crystalline carbon material described herein may be employed in many commercial products and industries.

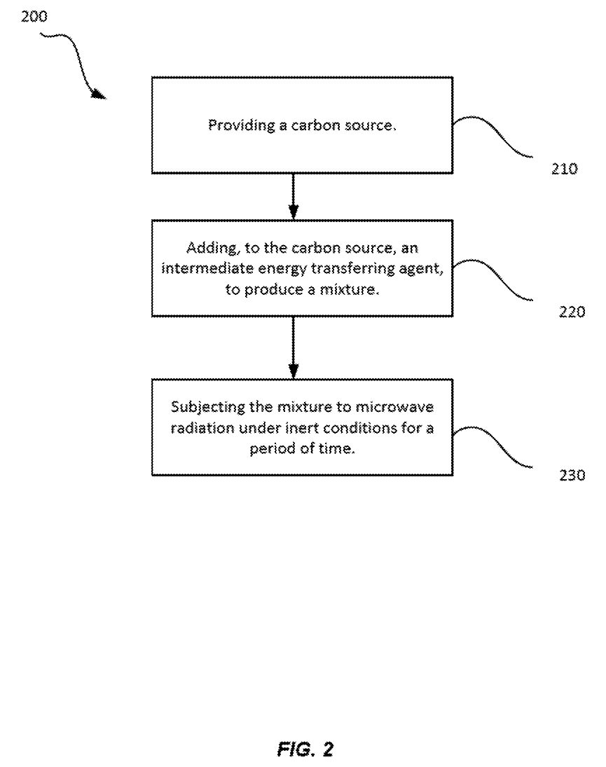

In another aspect, a method for producing a two-dimensional (2D) turbostratic or quasi-crystalline carbon material is provided. Referring to FIG. 2, the method 200 includes providing a carbon source (210), adding an intermediate energy transferring agent to the carbon source to produce a mixture (220), and subjecting the mixture to microwave radiation under inert conditions for a period of time to produce the 2D turbostratic or quasi-crystalline carbon material (230) with a surface area greater than 200 m²/g. In some embodiments, the 2D turbostratic or quasi-crystalline carbon material has a surface area of greater than 200 m²/g, 210 m²/g, 220 m²/g, 230 m²/g, 240 m²/g, 250 m²/g, 260 m²/g, 270 m²/g, 280m²/g, 290 m²/g, or 300 m²/g. A schematic of the formation of the turbostratic or quasi-crystalline material may be found in FIG. 3B.

In step 210, the carbon source is selected as described above. In step 220, an energy transferring agent is added to the carbon source. The energy transferring agent may be a material capable of efficiently absorbing microwave energy without introducing contamination. Non-limiting examples include high-purity graphite, certain ceramics, or even sacrificial microwave susceptors that can be separated from the final product. Other suitable energy transferring agents may include graphene, graphitic carbon, a nanocrystalline carbon, nanocrystalline graphite, or graphene derivatives. The choice of agent may be dictated by the need for clean energy transfer and minimal incorporation into the final carbon material. In some embodiments, the energy transferring agent is physically separated from the product after the synthesis is complete, ensuring higher purity of the resulting turbostratic or quasi-crystalline carbon.

In step 230, the mixture is subjected to microwave radiation, as described above, with the process conducted in an inert environment. This approach may be advantageous for synthesizing high-purity materials, as the energy transferring agent can be selected or configured so as not to remain in the final product, and inert conditions further reduce the risk of unwanted reactions. For example, a high purity product may refer to a material having at least 90% purity (i.e., 90% product material without reactants). The purity of the final product may be 90%, 91%, 92%, 93%, 94%, 95%, 96%, 97%, 98%, 99%, or 100%.

The structure and properties of the synthesized 2D turbostratic or quasi-crystalline carbon materials may be characterized using a variety of analytical techniques such as SEM, and TEM to confirm the layered, turbostratic morphology. In some embodiments, PXRD patterns may reveal the characteristic broadening and shifting of peaks associated with turbostratic disorder. In some embodiments, Raman spectroscopy may be used to reveal the emergence of D, G, or 2D peaks, indicating the transformation toward a more graphitic structure. In some embodiments, X-ray photoelectron spectroscopy (XPS) may be employed to monitor changes in bonding environments and oxygen content.

As described above, the synthesized materials are suitable for use in a variety of applications, including but not limited to energy storage devices (such as batteries and supercapacitors), catalysts, composite materials, environmental remediation, and sensors.

In another aspect, a product claim is directed to a 2D turbostratic or quasi-crystalline carbon material produced according to the methods described above. The product may be characterized by its unique layered morphology, high surface area, and the absence of significant impurities or contamination, as confirmed by electron microscopy, X-ray diffraction, and spectroscopic analysis.

The methods and products described herein provide a significant advance in the synthesis of high-value carbon materials, offering simplicity, scalability, and versatility. The process is applicable to a broad range of carbon sources and can be tailored to produce materials with desired structural and functional characteristics.

### Examples

In this example, the synthesis of two-dimensional (2D) turbostratic or quasi-crystalline carbon materials was performed using the microwave-assisted approaches described herein. The starting materials included carbon sources such as cellulose, lignin, coke waste, and coke fine ash, and each obtained from commercially available sources. In some instances, an intermediate energy transferring agent, such as a graphitic carbon material, was physically mixed with the carbon source to facilitate energy absorption during microwave irradiation.

The mixture of the carbon source and, where applicable, the intermediate energy transferring agent was placed in a suitable vessel and subjected to microwave radiation and further described below. The irradiation was carried out under conditions sufficient to induce the transformation of the starting material into a 2D turbostratic or quasi-crystalline carbon structure. In certain experiments, the synthesis was performed under an inert atmosphere (e.g., argon or nitrogen) to minimize oxidation and contamination.

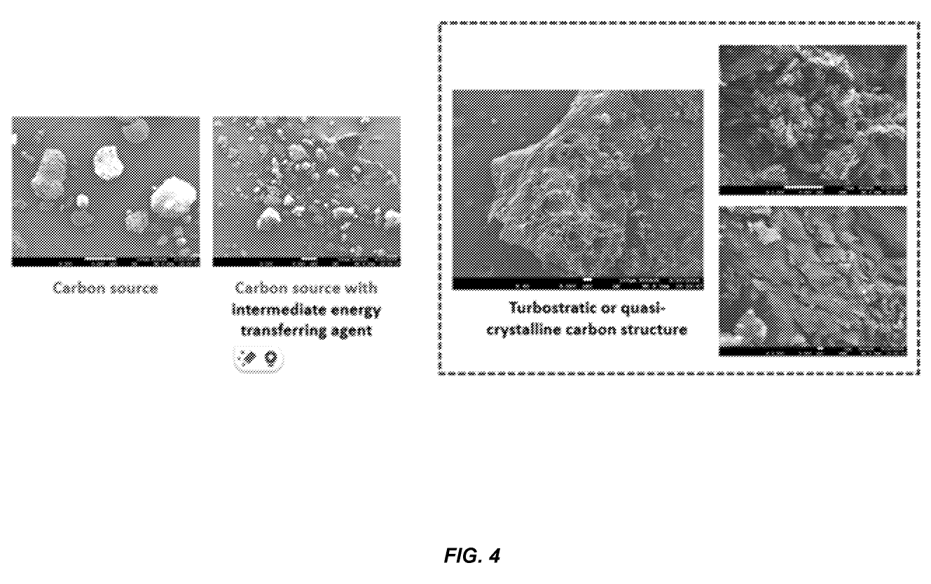

FIG. 4 shows scanning electron microscopy (SEM) images depicting the morphological features of turbostratic or quasi-crystalline carbon materials synthesized according to the methods described herein. As shown in the SEM images, the carbon source alone and mixed with the intermediate energy transferring agent appeared as small particulates having defined edges with a heterogeneous mixture of the particulates. Following microwave radiation, the SEM images confirmed successful production of the 2-D turbostratic or quasi-crystalline carbon materials that have a larger surface area than the starting materials. The turbostratic or quasi-crystalline carbon materials show clear fused larger carbon structures with layers which are characteristics of turbostratic or quasi-crystalline materials.

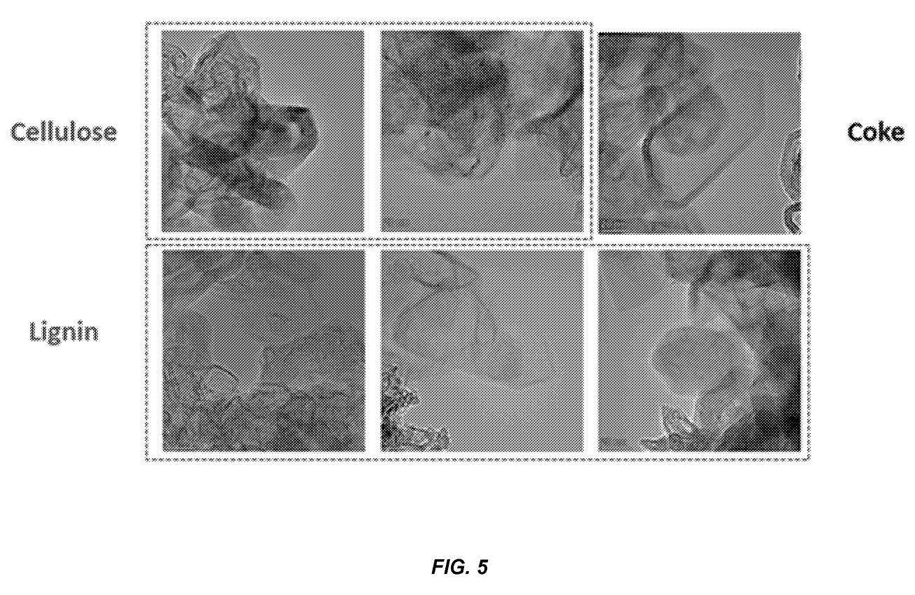

Further imaging analysis was carried out using TEM methods. FIG. 5 shows transmission electron microscopy (TEM) images demonstrating the microstructural characteristics of turbostratic or quasi-crystalline carbon materials synthesized from cellulose, coke, and lignin using the methods described herein. As demonstrated in the TEM images, the cellulose, coke, and lignin materials all generated clear fused larger carbon structures with layers and unaligned fringes, which are characteristic of turbostratic or quasi-crystalline materials.

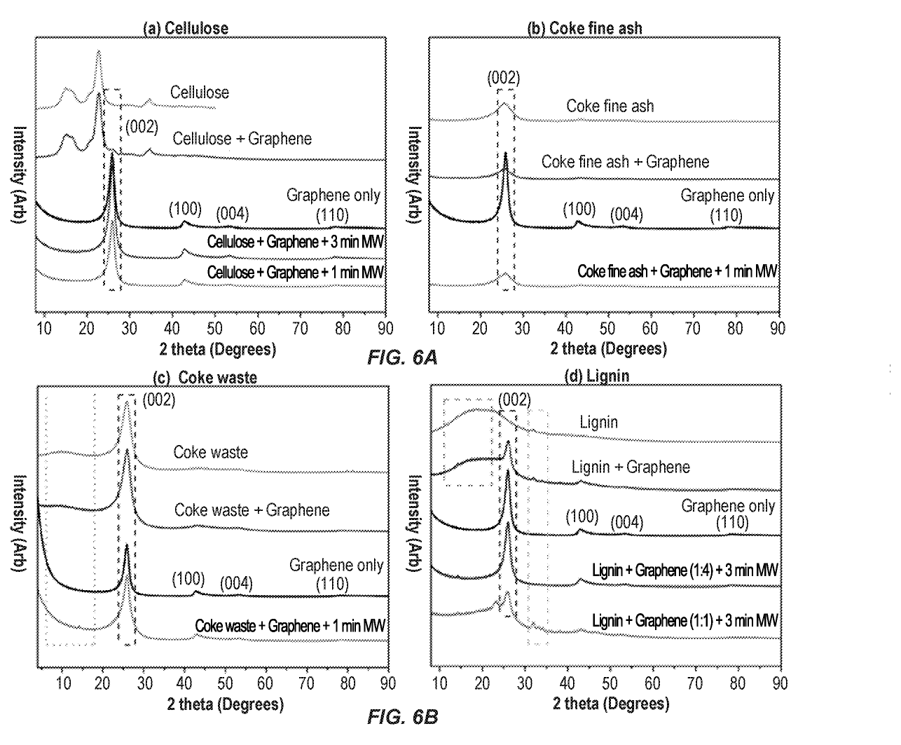

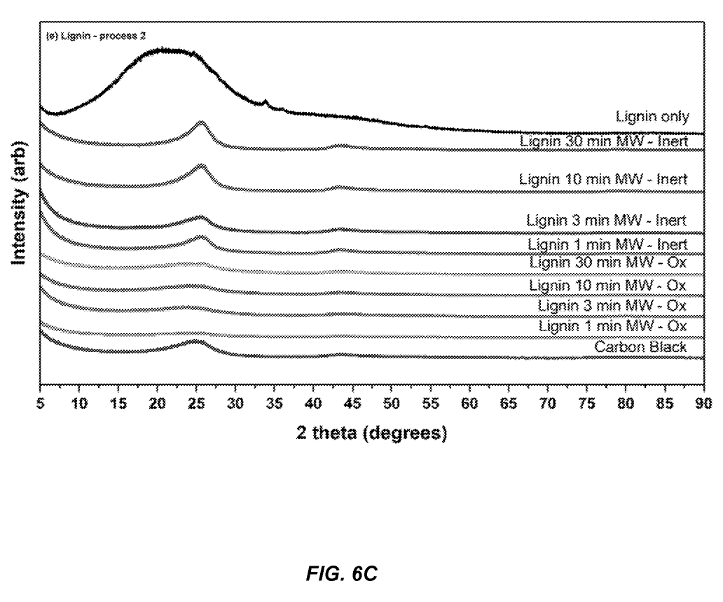

To evaluate the crystal structure of the materials before and after microwave radiation, PXRD analysis was performed on the materials. FIG. 6A shows powder X-ray diffraction (PXRD) analysis of turbostratic or quasi-crystalline carbon materials synthesized from (a) cellulose and (b) coke fine ash. FIG. 6B shows powder X-ray diffraction (PXRD) analysis of turbostratic or quasi-crystalline carbon materials synthesized from (c) coke waste and (d) lignin. The PXRD patterns of these samples after either 1 minute and 3 minutes of radiation demonstrated clear changes in their native crystalline and semi-crystalline structures, indicating transformation of the starting materials during the synthesis process. In particular, the emergence of new peaks and the alteration of peak intensities in the PXRD spectra provided evidence for the formation of turbostratic or quasi-crystalline carbon materials (FIGS. 6A-6B). The PXRD pattern of the intermediate energy-transferring agent, such as graphene, was also examined and was observed to remain substantially unchanged following the process, suggesting that the agent facilitated energy transfer without itself undergoing significant structural modification. Additionally, the PXRD analysis with lignin starting material at ratios of 1:1 and 1:4 with graphene was evaluated after 3 minutes of radiation. At a ratio of 1:4, the peaks of the starting material remained, while the peak intensity increased, providing evidence for the formation of turbostratic or quasi-crystalline carbon materials at higher ratios of energy transferring materials.

Furthermore, in the process variant wherein lignin was used as the carbon source and microwave irradiation was applied under inert conditions, the PXRD results revealed a greater degree of graphitization over time (FIG. 6C). This was evidenced by the increased intensity and sharpening of characteristic graphitic peaks in the PXRD spectra with extended microwave exposure, signifying the development of a more ordered, graphitic-like structure within the lignin-derived material. For example, under inert conditions, as the time of radiation increased from 1 minute to 30 minutes, a clear peak at 25 degrees increased. However, under oxygen atmosphere, as the time of radiation increased from 1 minute to 30 minutes, the peak at 25 degrees minimally increased. These findings support the effectiveness of the disclosed microwave-assisted process for converting diverse carbonaceous materials into turbostratic or quasi-crystalline carbon structures, and demonstrate that process parameters, such as the use of inert atmosphere and irradiation duration, can influence the degree of graphitization achieved.

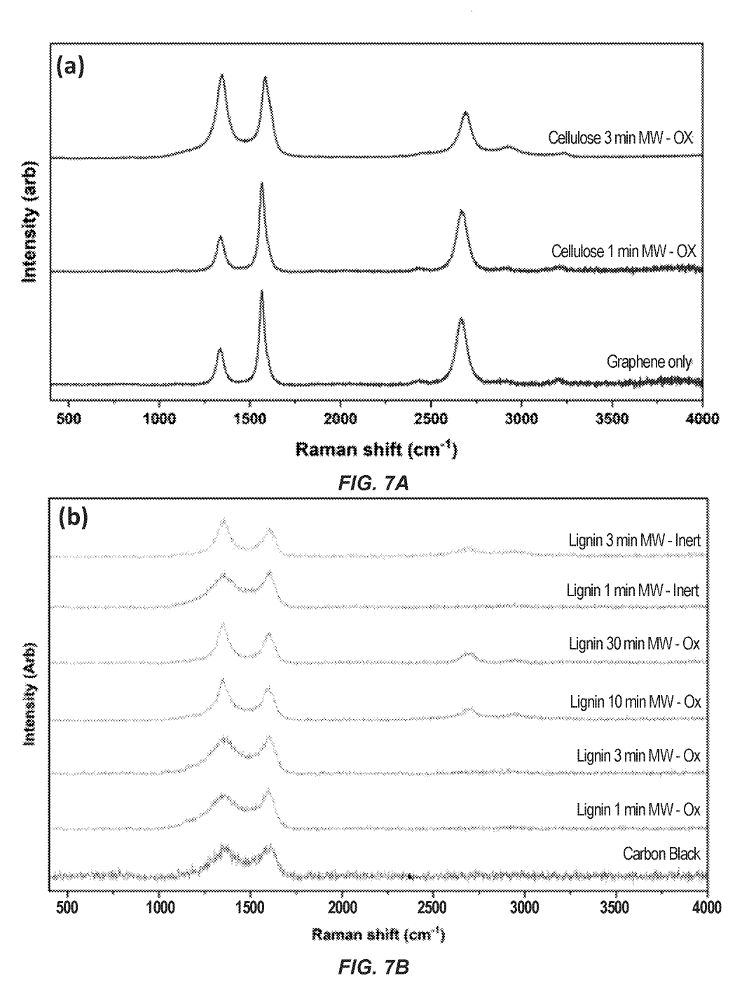

Raman spectroscopy was performed to characterize the structural evolution of the carbon materials following microwave irradiation. As shown in FIG. 7A, the Raman spectra of cellulose subjected to the process of FIG. 2 reveal the absence of characteristic D, G, or 2D peaks in the untreated starting material. However, after exposure to microwave radiation for 1 minute and 3 minutes, new peaks emerge in the spectral regions typically assigned to the D band (associated with disorder in sp^2 carbon systems), the G band (indicative of graphitic domains), and the 2D band (second-order two-phonon process), respectively. The increased intensity and definition of these peaks with longer irradiation times further supports a time-dependent transformation from the amorphous or semi-crystalline state toward a more ordered, graphitic-like structure.

Similarly, FIG. 7B presents the Raman spectra of lignin subjected to microwave irradiation under various durations and environmental conditions. The appearance of D and G bands in lignin samples, which are not present in the untreated material or the carbon black reference, provides further evidence of the successful conversion toward turbostratic or quasi-crystalline carbon structures. Notably, samples treated under inert gas conditions display more pronounced graphitic features compared to those irradiated in the presence of oxygen, indicating that the process atmosphere can influence the degree of structural ordering and graphitization achieved. The comparative analysis with reference materials, such as graphene and carbon black, further corroborates the assignment of these bands and the effectiveness of the microwave-assisted process in promoting the formation of two-dimensional, graphitic domains. These results collectively demonstrate that the described microwave-assisted synthesis induces substantial structural reorganization in both cellulose and lignin precursors, as evidenced by the emergence of graphitic Raman signatures, thereby validating the efficacy of the process for producing turbostratic or quasi-crystalline carbon materials.

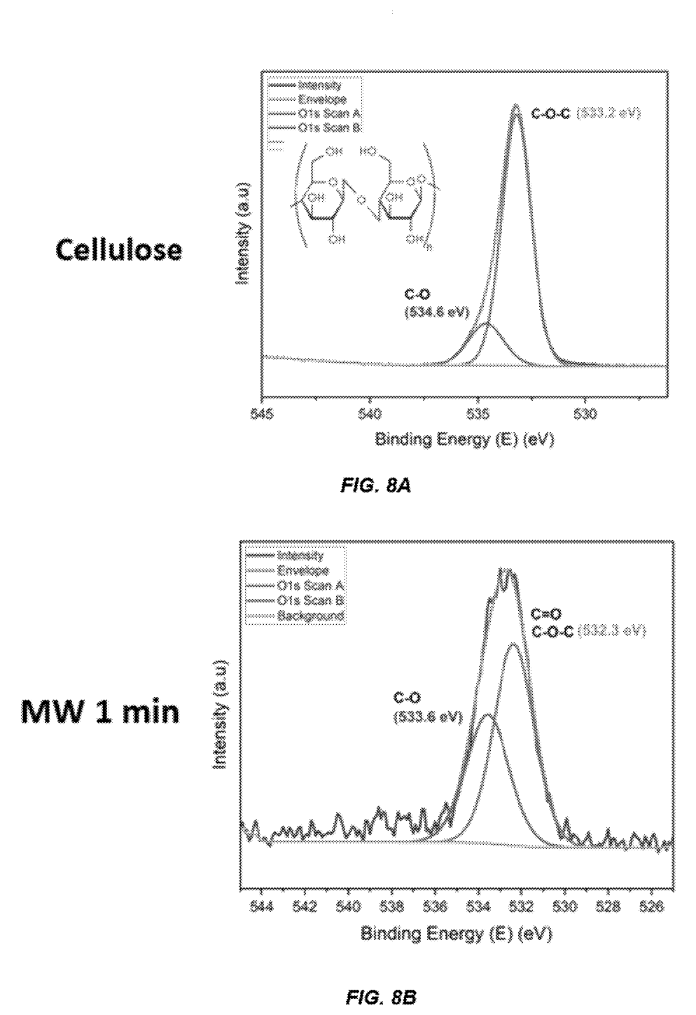

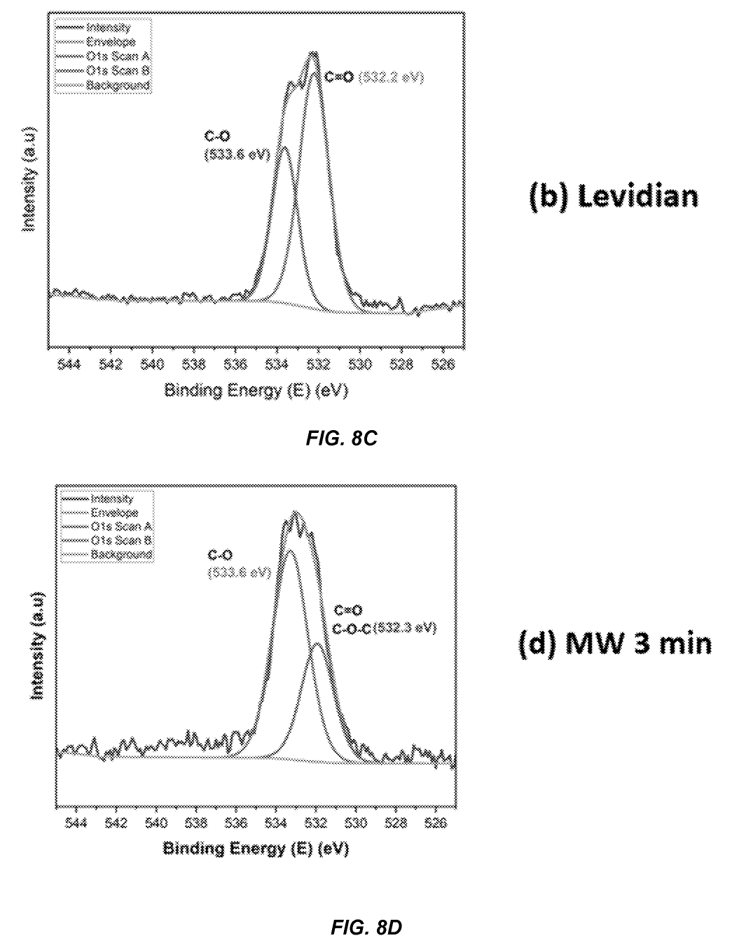

And finally, X-ray photoelectron spectroscopy (XPS) analysis was performed to investigate the chemical and structural evolution of the carbon materials during microwave-assisted synthesis as described herein. FIG. 8A presents the O1s narrow scan spectra of cellulose prior to microwave irradiation, while FIG. 8B shows the corresponding spectra for the turbostratic or quasi-crystalline carbon material synthesized from cellulose using microwave irradiation for 1 minute. Similarly, FIGS. 8C, and 8D display the O1s spectra for lignin before and after microwave treatment for 3 minutes, respectively. In the case of untreated cellulose, the O1s spectrum exhibits a prominent peak at 533.2 eV, which is attributed to the C-O-C functional group present in the β(1→4) linked D-glucose units characteristic of native cellulose. After subjecting the cellulose to microwave irradiation, a significant change in the intensity and position of this peak is observed. This alteration is indicative of a transformation in the chemical environment of oxygen, consistent with the breakdown of the original polysaccharide structure and the formation of new carbon-oxygen functionalities associated with a more disordered, graphitic, or quasi-crystalline material.

A similar trend is observed with lignin (FIGS. 8C-8D), where the O1s spectra before and after microwave treatment reveal notable changes in the chemical states of oxygen. These findings support the conclusion that the microwave-assisted process induces substantial structural modification, leading to the conversion of the starting biopolymer into a turbostratic or quasi-crystalline carbon framework. The observed modifications in the XPS spectra, together with complementary characterization methods such as PXRD and Raman analysis, provide strong evidence for the effectiveness of the described method in generating advanced carbon materials with tunable properties. These results demonstrate that XPS is a valuable tool for tracking the chemical transformation of precursor materials and confirm the potential of this facile, scalable technique for producing customized quasi-crystalline carbon structures suitable for a range of advanced applications.

In summary, the combination of structural, spectroscopic, and compositional analyses demonstrates the efficacy of the disclosed microwave-assisted synthesis method for producing two-dimensional turbostratic or quasi-crystalline carbon materials from diverse carbon sources. Scanning electron microscopy (SEM) and transmission electron microscopy (TEM) analyses revealed clear morphological transformations and the formation of characteristic layered structures following microwave irradiation. Powder X-ray diffraction (PXRD) patterns confirmed the conversion of native crystalline or semi-crystalline carbon sources to products exhibiting the distinct signatures of turbostratic or quasi-crystalline forms, while also verifying that the intermediate energy-transferring agent retained its structure throughout the process. Raman spectroscopic studies provided compelling evidence of increased graphitization, as indicated by the emergence of D, G, and 2D bands in the irradiated samples, features absent in the starting lignin and cellulose materials. Furthermore, X-ray photoelectron spectroscopy (XPS) analyses corroborated the occurrence of significant chemical changes, with the transformation of the C-O-C environment in cellulose and the overall modification of surface chemistry following microwave treatment. Collectively, these results establish that the described methods reproducibly yield turbostratic or quasi-crystalline carbon materials with desirable structural and compositional attributes, validating the approach as a facile, scalable, and versatile route for the synthesis of advanced carbon nanomaterials suitable for a wide range of applications.

What is claimed is:

1. A method of producing a 2D carbon structure, the method comprising:
providing a carbon source;
adding, to the carbon source, an intermediate energy transferring agent, to produce a mixture; and
subjecting the mixture to microwave radiation for a period of time to produce the 2D carbon structure, wherein the 2D carbon structure is a turbostratic or quasi-crystalline carbon material.

2. The method of claim 1, wherein the carbon source is cellulose, lignin, coke, or a combination thereof.

3. The method of claim 1, wherein the intermediate energy transferring agent comprises a graphitic carbon material, graphene, a nanocrystalline carbon material, or a graphene derivative.

4. The method of claim 1, wherein the microwave radiation is applied in an inert environment.

5. The method of claim 1, wherein the microwave radiation is applied for a period of time from 0.5 minutes to 60 minutes.

6. The method of claim 1, wherein the mixture is subjected to microwave radiation at a power of at least 500 Watts.

7. The method of claim 1, further comprising isolating the 2D carbon structure from the mixture after microwave irradiation.

8. The method of claim 1, wherein the 2D carbon structure produced has a higher purity than the carbon source.

9. The method of claim 1, wherein the microwave radiation is applied at a frequency in a range from about 300 MHz to about 30 GHz.

10. A method of producing a turbostratic or quasi-crystalline carbon material, comprising:
providing a carbon source:
adding, to the carbon source, an energy transferring agent to produce a mixture; and
subjecting the mixture to microwave radiation under inert conditions for a period of time, thereby producing a turbostratic or quasi-crystalline carbon material.

11. The method of claim 10, wherein the energy transferring agent is selected from the group consisting of high purity graphite, ceramics, sacrificial microwave susceptors, graphene, graphitic carbon, a nanocrystalline carbon, or a graphene derivative, and wherein the energy transferring agent provides energy to the carbon source without contaminating the turbostratic or quasi-crystalline carbon material, and wherein the turbostratic or quasi-crystalline carbon material has a surface area of greater than 200 m²/g.

12. The method of claim 10, wherein the inert conditions comprise an atmosphere of argon or nitrogen.

13. The method of claim 10, wherein the carbon source is selected from waste biomass, coke waste, or industrial byproducts.

14. The method of claim 10, wherein the turbostratic or quasi-crystalline carbon material is characterized by unaligned fringes as observed in transmission electron microscopy.

15. The method of claim 10, wherein the process yields a product with improved electrical conductivity compared to the carbon source.

16. The method of claim 10, further comprising using the turbostratic or quasi-crystalline carbon material as an electrode material in an energy storage device.

17. The method of claim 10, wherein the turbostratic or quasi-crystalline carbon material has a purity of at least 95%.

18. The method of claim 10, wherein the turbostratic or quasi-crystalline carbon material is suitable for use in water purification or sensor applications.

19. A two-dimensional (2D) turbostratic or quasi-crystalline carbon material produced by the method of claim 1 or 10.

20. The product of claim 19, wherein the carbon material exhibits a Raman spectrum with D, G, and 2D peaks.
